(19) United States
(12) Patent Application Publication
(10) Pub. No.: US 2018/0257261 A1
(43) Pub. Date: Sep. 13, 2018

(54) PORTABLE TILE SAW

(71) Applicant: TECHTRONIC POWER TOOLS TECHNOLOGY LIMITED, Tortola (VG)

(72) Inventors: Alek Ipatenco, Belton, SC (US); Michael Hart, Anderson, SC (US); C. Scott Tennant, Clemson, SC (US); Kenneth Brazell, Piedmont, SC (US); Jesse J. Jerabek, Easley, SC (US); Taku Ohi, Greer, SC (US)

(21) Appl. No.: 15/975,057

(22) Filed: May 9, 2018

Related U.S. Application Data
(63) Continuation-in-part of application No. 13/832,287, filed on Mar. 15, 2013.

(51) Int. Cl. B28D 1/04; B28D 7/02

(52) U.S. Cl. CPC B28D 1/047; B28D 7/02

(57) ABSTRACT

A tile saw includes a frame supporting a saw, a table, and pan. The pan includes an inside bottom surface and an outer wall defined by a first end wall, a second end wall spaced away from the first end wall, and first and second side walls extending between the first end wall and the second end wall. A connection assembly couples the frame to the pan, and includes a first engagement member disposed on the first end wall, and second and third engagement members disposed on the second end wall. A stand includes a plurality of legs that support the pan. A transport assembly transports the pan, the table, and the frame separately from the stand. The transport assembly includes wheels coupled to one of the first end wall or second end wall, and a handle coupled to the other of the first end wall or second end wall.

### CROSS-REFERENCE TO RELATED APPLICATIONS

This application is a continuation-in-part of U.S. patent application Ser. No. 13/832,287, filed Mar. 15, 2013, the entire content of which is incorporated herein by reference.

### BACKGROUND

Tile saws are usually supported on stands, which may or may not be collapsible for transport. Such tile saws, however, require disassembly for transport because the assembled components of the tile saw (e.g., a pan, a frame, a workpiece supporting table, and a saw) are too heavy or large to carry by hand.

### SUMMARY

The present invention provides, in one aspect, a tile saw including a frame supporting a saw, a table having a planar surface configured to support a workpiece, the table being slidable relative to the frame, and a pan configured to support the frame. The pan includes an inside bottom surface and an outer wall defining a volume capable of containing a liquid. The outer wall is defined by a first end wall, a second end wall spaced away from the first end wall, and first and second side walls extending between the first end wall and the second end wall. The tile saw also includes a connection assembly configured to removably couple the frame to the pan. The connection assembly has a first engagement member disposed on the first end wall of the pan and second and third engagement members disposed on the second end wall of the pan. The tile saw further includes a stand having a plurality of legs for supporting the pan and a transport assembly for transporting the pan, the table, and the frame separately from the stand. The transport assembly includes a plurality of wheels coupled to one of the first end wall or second end wall of the pan, and a handle coupled to the other of the first end wall or second end wall of the pan.

The present invention provides, in another aspect, a pan for use with a tile saw having a frame and a saw supported on the frame. The pan includes an inside bottom surface, an outer wall extending around a perimeter of the inside bottom surface and together with the inside bottom surface, defining a volume capable of containing a liquid. The outer wall is formed by a first end wall, a second end wall spaced away from the first end wall, and first and second side walls extending between the first end wall and the second end wall. The pan also includes first and second platforms configured to engage and support the frame within the pan. The first and second platforms are positioned within the outer wall of the pan and have a height that is lower than a height of the outer wall. The pan further includes a connection assembly configured to removably couple the frame to the pan. The connection assembly has a first engagement member disposed on the first end wall of the pan and second and third engagement members disposed on the second end wall of the pan. The pan also includes a transport assembly for transporting the pan with the frame and saw attached thereto. The transport assembly includes a plurality of wheels coupled to one of the first end wall or second end wall of the pan, and a handle coupled to the other of the first end wall or second end wall of the pan.

Other aspects of the invention will become apparent by consideration of the detailed description and accompanying drawings.

### BRIEF DESCRIPTION OF THE DRAWINGS

FIG. 1 is a perspective view of a wet tile saw supported on a stand;

FIG. 2 is a perspective view of a pan for a wet tile saw supported on the stand;

FIG. 3 is an enlarged perspective view of a latch;

FIG. 4 is an enlarged perspective view of one end of the pan and frame in an assembled condition;

FIG. 5 is an enlarged perspective view of the end of the pan of FIG. 4 with the frame removed;

FIG. 6 is a perspective view of a bottom of one end of the pan illustrating a pair of wheels; and

FIG. 7 is a perspective view of a handle of the pan.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

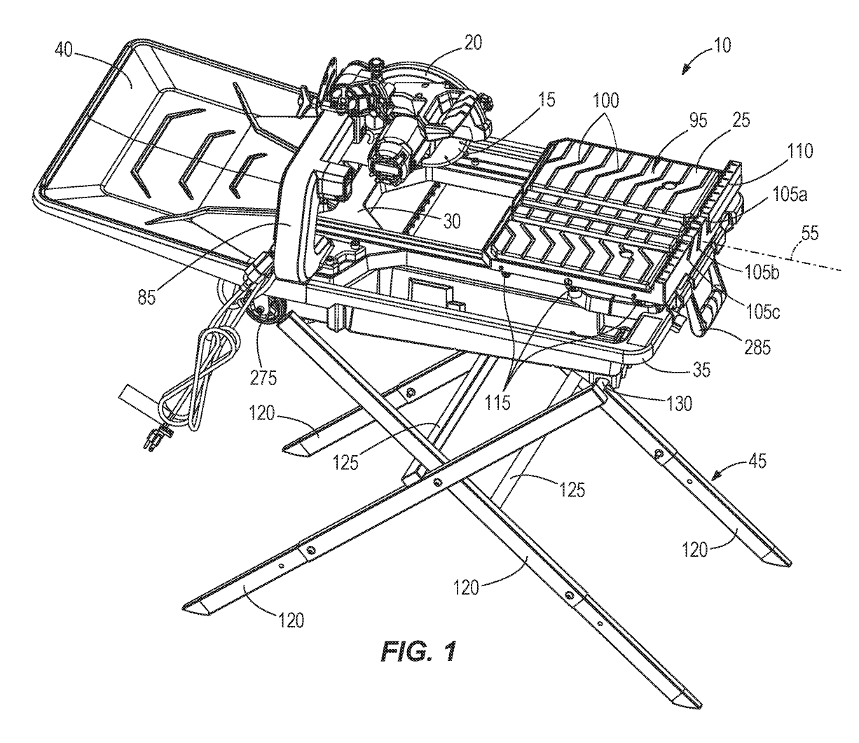

The present invention provides a wet tile saw 10 that can be used to accurately and quickly cut construction materials such as ceramic, marble, or granite tiles and the like. The tile saw 10 employs a lubricant such as water to cool a cutting blade 15 and to carry away debris removed during the cutting process. As illustrated in FIG. 1, the wet tile saw 10 includes a saw 20, a table 25, a frame 30, a pan 35, an extension 40, and a stand 45 that supports the other components at a suitable working height.

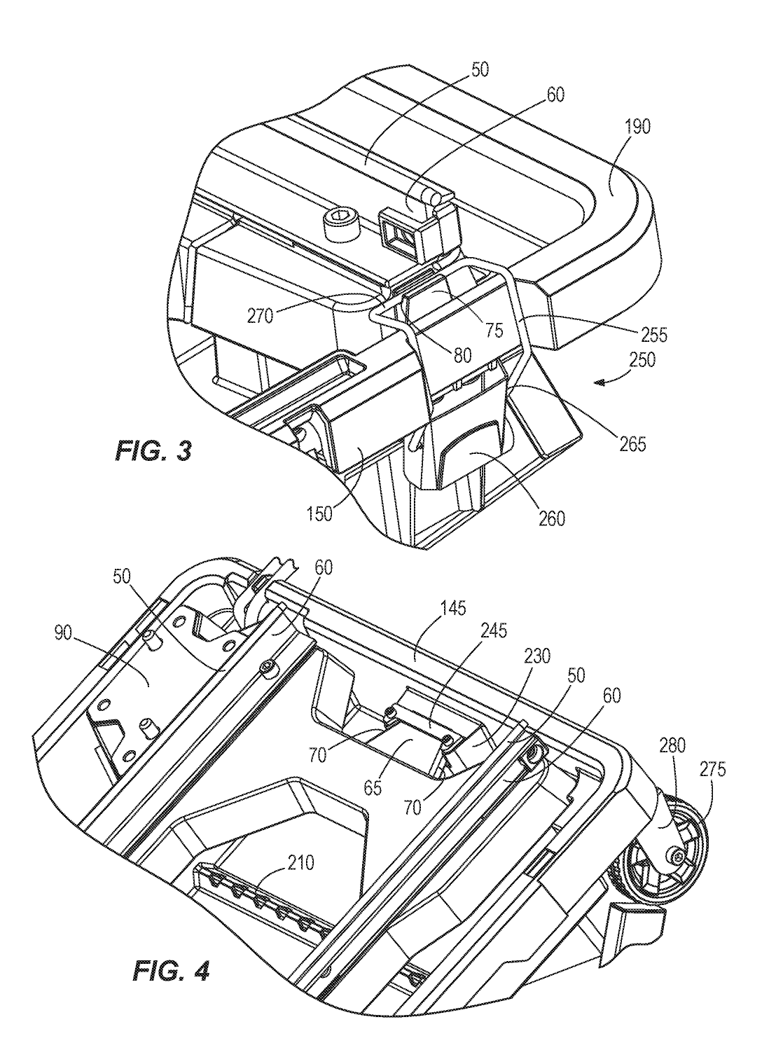

The frame 30 is a structural component that includes a pair of rails 50 that extend along a longitudinal axis 55 of the tile saw 10 and cooperate to define a guide. As is best illustrated in FIGS. 3 and 4, the rails 50 are spaced apart from one another such that they are on opposite sides of the frame 30. In the illustrated construction, the rails 50 are substantially cylindrical rods that extend the length of the frame 30 and that are supported by a structural member 60 such as a channel component or an I-beam component. Each rail 50 is supported in a manner that allows for engagement of a bottom portion of the rail 50 as well as a top portion as will be discussed below.

The frame 30 also includes an engagement member in the form of a tab 65 that extends from one end of the frame 30 between the rails 50. As is best illustrated in FIG. 4, the tab 65 is a trapezoidal member that includes a narrow portion spaced away from the frame 30 and a wider portion at the frame 30. Thus, the tab 65 narrows as it extends away from the frame 30 and defines two tapered surfaces 70. While the illustrated tab 65 is trapezoidal, other shapes or combinations could be employed. For example, a cylindrical or conical tab could be employed. In addition, multiple tabs of different shapes could be employed in place of or in conjunction with the illustrated tab 65.

With reference to FIG. 3, the frame 30 also includes additional engagement members in the form of two hook members 75. FIG. 3 illustrates one of the hook members 75 which is substantially aligned with one of the rails 50. The other hook member 75 is positioned adjacent the same end of the opposite rail 50. Each hook member 75 defines a slot 80 that is preferably cylindrical and that extends in a direction substantially perpendicular to the longitudinal axis 55 of the saw 10. In preferred constructions, the slots 80 of the two hook members 75 are substantially aligned along a common axis. In the construction of FIG. 3, the hook members 75 are formed as part of the frame 30. However, other constructions may include hook members 75 that attach to the frame 30 using a fastener or other attachment means.

With reference to FIG. 1, the saw 10 includes an electrically-powered circular saw 20 (line powered or battery powered) supported by an arm 85 that fixedly attaches to a platform 90 of the frame 30. The arm 85 is shaped to support the saw 20 over the frame 30 in a position where the cutting blade 15 is approximately centered between the rails 50. The saw 20 supports the cutting blade 15 for rotation about an axis that is substantially normal to the axis of the saw 55. In preferred constructions, the circular saw 20 is movable to position the blade 15 at an angle that allows for angled cuts as well as the more common vertical or straight cuts.

With continued reference to FIG. 1, the table 25 includes a substantially planar top surface 95 that is arranged to support a workpiece to be cut. The top surface 95 includes a plurality of grooves or slots 100 arranged to direct the liquid coolant and collected cutting debris off the table and into the pan. In addition, the table includes three slots 105 that extend parallel to the saw axis 55 and that are shaped to receive the cutting blade 15 during a cut. A first of the slots 105a is arranged to receive the blade 15 during a vertical cut and is therefore substantially vertical. A second slot 105b is angled at a first angle (e.g., 45 degrees from vertical) to receive the saw blade 15 during a bevel cut at the first angle. A third slot 105c is angled at a second angle (e.g., 60 degrees from vertical) to receive the saw blade 15 during a bevel cut at the second angle. Additional slots 105 could be provided at different angles if desired.

The table 25 also includes a rear fence 110 that provides support for the workpiece as it is being pushed into the blade 15 during the cutting operation. In the illustrated construction, the fence 110 includes measuring indicia that help the user during the cut setup. In addition, the three slots 105 pass through the fence 110 to provide clearance for the cutting blade 15 during a cutting operation. In some constructions, a second fence is attachable to the table 25 to provide lateral support for the workpiece during a cut. Preferably, the second fence can be angled to support the workpiece in a non-square position to make cuts that are not parallel to the edges of the workpiece.

With continued reference to FIG. 1, the table 25 includes a plurality of roller elements 115 that are arranged to engage the rails 50 and support the table 25 on the rails 50. In the illustrated construction, three roller elements 115 are positioned on each side of the table 25 to engage the rail 50 on that side of the table 25. At least two of the roller elements 115 include a bottom roller that engages the bottom surface of the rail 50. The bottom rollers inhibit unwanted upward movement of the table 25 during a cutting operation. At least two of the roller elements 115 on each side also include a top element that engages the top surface of the rail 50 to support the table 25 for smooth rolling movement along the rails 50. In other constructions, the top and bottom rollers are replaced by linear bearings or other components that engage both sides of the rail 50 and inhibit all movement in directions normal to the rail 50.

The extension 40, best illustrated in FIG. 1 attaches to the pan 35, the frame 30, or the stand 45 and extends beyond the pan 35 behind the saw 20. The extension 40 is angled to catch lubricant that splashes in the rearward direction and direct the lubricant back to the pan 35. In some constructions, one or more side extensions are also employed to perform a similar function along the sides of the pan 35.

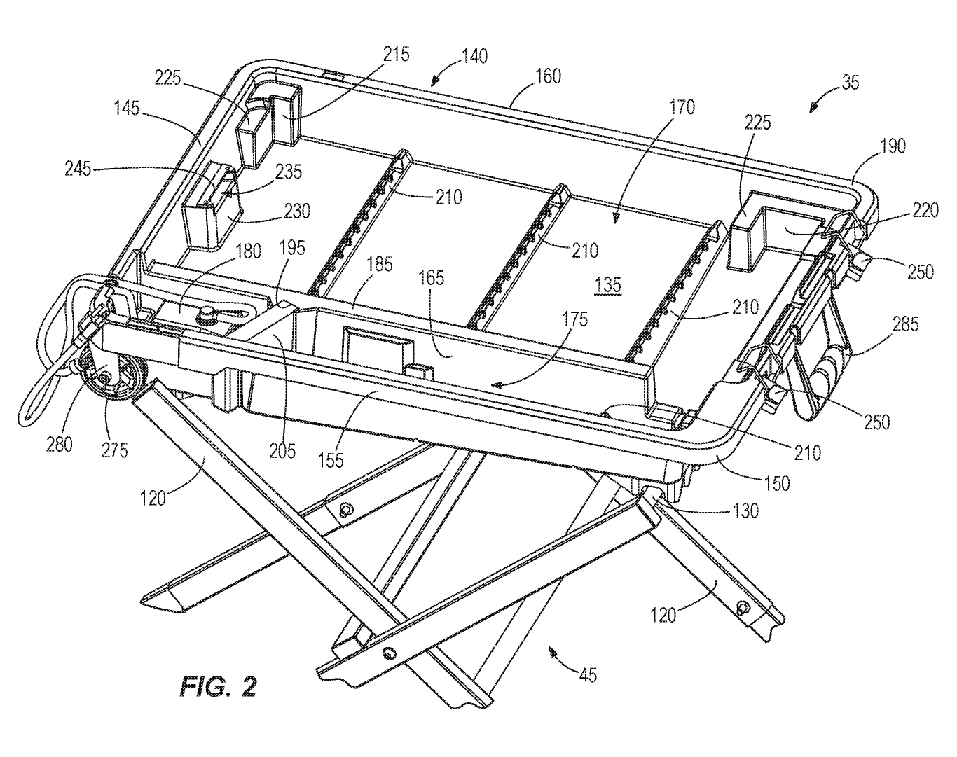

The stand 45, illustrated in FIGS. 1 and 2 includes four legs 120 attached to one another in pairs to define two similar side members 122 that move in a manner similar to a scissors. Each leg 120 includes a bottom portion that is adjustable to allow the user to adjust the ultimate height of the saw 10. Lateral members 125 extend between the two side members 122 and connect them to one another. In addition, two rods 130 extend across the upper ends of the legs 120 to interconnect the side members 122 and to provide an attachment point for the pan 35. In the illustrated construction, the rods 130 are cylindrical with other shapes or arrangements being possible.

Turning to FIG. 2, the pan 35 is shown with many of the other components removed. The pan 35 includes an inside bottom surface 135 that is surrounded by an outer wall 140 to define a volume that is capable of containing a liquid, typically water or other lubricants or coolants. In the illustrated construction, the outer wall 140 is substantially rectangular and includes a first end wall 145, a second end wall 150, a first side wall 155, and a second side wall 160. Of course other shaped outer walls 140 having more or fewer sides could be employed if desired.

An inner wall 165 extends between the first end wall 145 and the second end wall 150 in a direction substantially parallel to the first side wall 155. The inner wall 165 divides the volume into a large volume 170 and a small volume 175. A pump 180 is disposed in a corner between the inner wall 165 and the first side wall 155 adjacent the first end wall 145. The inner wall 165 has a height that positions a top surface 185 of the inner wall 165 at a level that is below a top surface 190 of the outer wall 140. In addition, a portion of the inner wall 165 is removed at the end opposite the pump 180 such that the top surface of the wall in this removed area is lower than the top surface 185 of the remainder of the inner wall 165.

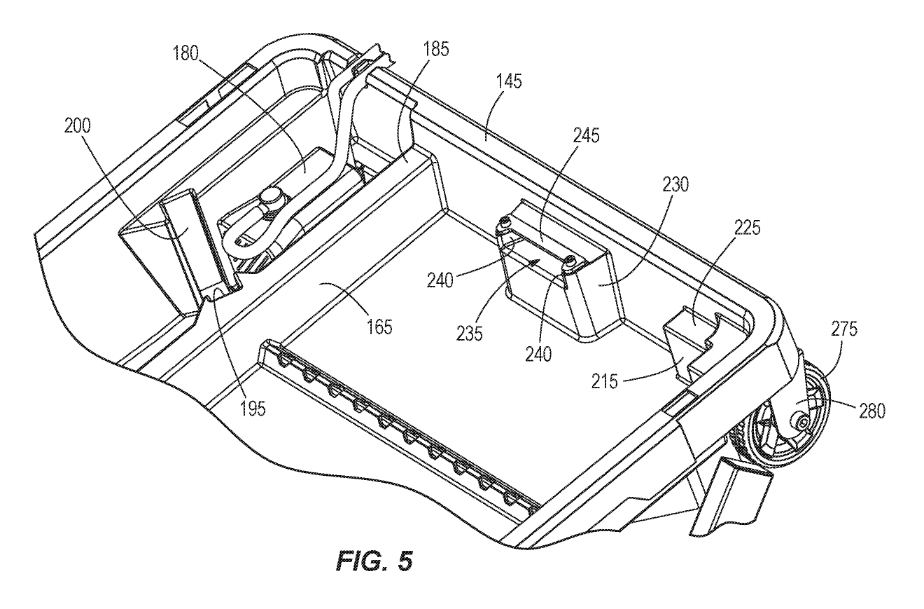

The inner wall 165 includes a first vertical slot 195 and the first side wall 155 includes a similar second vertical slot 200, best illustrated in FIG. 5. In the illustrated construction, the first vertical slot 195 and the second vertical slot 200 are axially offset from one another and are sized to receive a filter 205. The offset of the slots 195, 200 results in the filter 205 being supported at an oblique angle with respect to the saw axis 55 as shown in FIG. 2. In other constructions, the slots 195, 200 are not axially offset and the filter 205 is supported in a position that is substantially normal to the axis 55.

Several dams 210 extend across the bottom surface 135 between the second side wall 160 and the inner wall 165 and between the inner wall 165 and the first side wall 155. The dams 20 are formed and positioned to inhibit the passage of cutting debris. In the illustrated construction, three dams 210 are employed between the second side wall 160 and the inner wall 165 and two dams 210 are positioned between the inner wall 165 and the first side wall 155, with more or fewer being possible.

A first platform 215 is formed in the corner between the first end wall 145 and the second side wall 160 and a second platform 220 is formed in the corner between the second side wall 160 and the second end wall 150. The platforms 215, 220 include top surfaces 225 that are set at a height below the top surface 190 of the outer walls 140. The heights of the first platform 215, the second platform 220, and the inner wall 165 are selected to support the frame 30 at a desired height above the bottom surface 135 of the pan 35.

An engagement member in the form of an engagement platform 230, best illustrated in FIG. 5, is formed adjacent the center of the first end wall 145. The engagement platform 230 extends upward from the inside bottom surface 135 to a desired height. A pocket 235 is formed in the engagement platform 230 and is sized and shaped to receive the tab 65 of the frame 30 as illustrated in FIG. 4. In the illustrated construction, the pocket 235 includes side walls 240 that taper inward to receive the trapezoidal tab 65. A cover plate 245 attaches to the top of the engagement platform 230 and covers a portion of the pocket 235 to partially enclose the pocket 235. In other constructions, the cover plate 245 is formed as part of the engagement platform 230.

With reference to FIGS. 2 and 3, the pan 35 includes two additional engagement members in the form of latches 250 that are movably attached to the pan 35 to selectively engage and couple the frame 30 to the pan 35. With reference to FIG. 3, the latch 250 is an over-center latch that includes a hook 255 and an actuator 260. The actuator 260 is pivotally attached to the pan 35 and a first end 265 of the hook 255 is pivotally attached to the actuator 260. A second end 270 of the hook 255 selectively engages one of the slots 80 of the adjacent hook member 75. The actuator 260 is movable between a non-engaged position in which the second end 270 of the hook 255 is movable into and out of engagement with the slot 80 and an engaged position in which the second end 270 of the hook 255 is disposed within the slot 80 and the hook 255 is pulled downward to firmly connect the frame 30 and the pan 35.

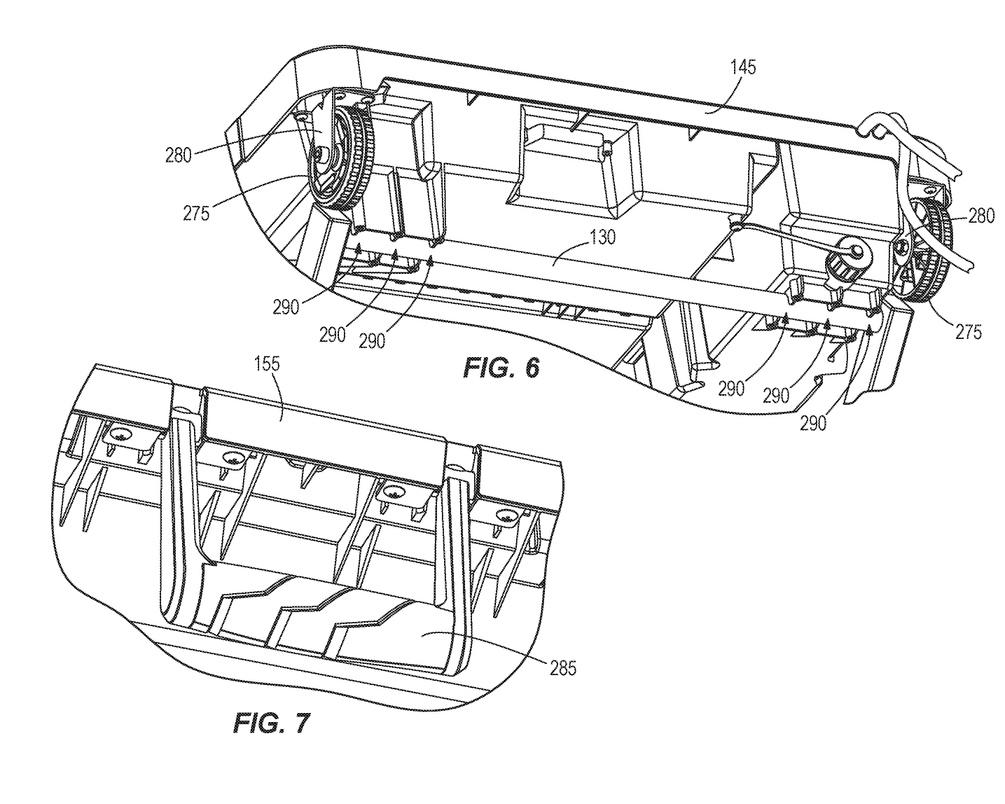

As illustrated in FIGS. 2 and 6, the pan 35 also includes two wheels 275 supported for rotation adjacent the first end wall 145. Each wheel 275 is supported for rotation on a bracket 280 which is in turn attached to the pan 35. In some embodiments the brackets 280 are integral with the pan 35. In the illustrated embodiment, the wheels 275 are connected to the pan at a location outside of the outer wall 140. In the illustrated construction, the wheels 275 are disposed closely to the corners of the first end wall 145 and the first side wall 155 and the first end wall 145 and the second side wall 160, with other positions and arrangements being possible.

With reference to FIGS. 2 and 7 a handle 285 is coupled to the pan 35 adjacent the second end wall 150 opposite the wheels 275. The handle 285 is generally U-shaped and is pivotally connected to the second end wall 150 and allows a user to pull the pan 35 while the two wheels 275 engage and roll along the ground.

As illustrated in FIG. 6, the bottom of the pan includes a plurality of slots 290 formed in two groups on opposite sides of the pan 35. In the illustrated construction, three C-shaped slots 290 are clustered on each side and are aligned along a common axis. The C-shaped slots 290 are sized to receive the rods 130 of the stand 45 to securely couple the pan 35 to the stand 45. A similar arrangement of C-shaped slots 290 is formed on the opposite end of the pan 35 to receive the second rod 130 of the stand 45.

With reference to FIGS. 1, 3, and 4, the assembly of the wet tile saw 10 will now be described. The pan 35 is connected to the stand 45 by pushing the pan 35 downward firmly to engage the C-shaped slots 290 with the rods 130. As the rod 130 slides into the slots 290, the C-shape inhibits the unwanted removal and provides a secure coupling. Next, the user places the pump 180 and the frame 30 into the pan 35. The pump 180 is placed in the corner and the power connections and liquid feed lines are positioned as illustrated in FIG. 4.

The frame 30 is connected to the pan 35 by a connection assembly, which includes the following engagement members: the tab 65 and the pocket 235, and the latches 250 and hooks 75. Together these engagement members of the connection assembly form a triangular arrangement. The triangular arrangement of the connection assembly enables the user to quickly and efficiently assembly and disassemble the frame 30 from the pan 35. The tab 65 and the pocket 235 are engaged first and help guide the frame 30 into position relative to the pan 35. The latches 250 and hooks 75 then help secure the frame 30 within the pan 35.

More specifically, the frame 30 is connected to the pan 35 by inserting the tab 65 into the pocket 235 and sliding the frame in a horizontal direction and then lowering the frame 30 into the pan 35 until the frame 30 engages with the inner wall 165, the first platform 215, and the second platform 220. The frame 30 is supported by the inner wall 165, the first platform 215, and the second platform 220 such that the frame platform 90 covers the pump 180. The tab 65 fits within the pocket 235 with the tapered side walls 70, 240 engaging one another to align the frame 30 and restrain unwanted lateral movement. The cover plate 245 is then attached to the engagement platform 230 to inhibit unwanted upward movement of the tap 65 with respect to the pan 35. The latches 25 are then engaged with the frame 30 as illustrated in FIG. 3 to removably couple the frame 30 to the pan 35. The arm 85 supporting the saw 20 is then attached to the frame platform 90 and the table 25 is positioned on the rails 50 of the frame 30 to complete the assembly of the saw 10. Of course, one of ordinary skill in the art will realize that a different assembly process or order could be employed if desired.

In operation, the assembled saw 10 is positioned at the desired height for use. Water or another coolant is placed in the pan 35 until the pan 35 is filled to a desired operating level. Next, the piece to be cut is positioned on the table 25 and the saw blade 15 is positioned as desired. The saw 20 and the pump 180 are then started. The pump's operation could be tied to the saw 20 such that operation of the saw 20 automatically starts operation of the pump 180. Alternatively, the pump 180 and the saw 20 can be started and stopped separately. The pump 180 directs coolant to the desired locations around the workpiece and the cutting blade 15. The table 25 is then moved to engage the workpiece and the cutting blade 15 to make the desired cut. As material is removed, the coolant carries away both heat and cutting debris and drains back into the pan 35. The debris also collects in the pan 35 and settles to the bottom. As the coolant is drawn into the pump 180, the coolant flows past the dams 210 in the large volume 170. The dams 210 inhibit movement of the debris to aid in separating the debris from the coolant. Eventually, the coolant flows around the inner wall 165 and along the small volume 175 toward the pump 180. The arrangement of the inner wall 165 assures a long flow path for the coolant to allow sufficient time for the entrained debris to settle to the bottom. The filter 205 acts as a final filter to assure that debris is not drawn into the pump 180.

The saw 10 includes a transport assembly including the handle 285 and the wheels 275. The transport assembly allows the user to transport the pan 35, the frame 30, and the table 25 together, and separately from the stand 45. For example, when a user wishes to move the saw 10, the pan 35 is removed from the stand 45 and placed on the ground. In the illustrated embodiment, the pan 35 can be removed from the stand 45 with the frame 30 and the table 25 still connected to the pan 35. The user then grabs the handle 285 and picks up the second end of the saw 10. The wheels 275 rotate into contact with the ground, thereby allowing the user to pull the assembly 10 along the ground.

Various features and advantages of the invention are set forth in the following claims.

1. A tile saw comprising:
a frame supporting a saw;
a table having a planar surface configured to support a workpiece, the table being slidable relative to the frame;
a pan configured to support the frame, the pan including an inside bottom surface and an outer wall defining a volume capable of containing a liquid, the outer wall defined by a first end wall, a second end wall spaced away from the first end wall, and first and second side walls extending between the first end wall and the second end wall;
a connection assembly configured to removably couple the frame to the pan, the connection assembly having a first engagement member disposed on the first end wall of the pan and second and third engagement members disposed on the second end wall of the pan;
a stand including a plurality of legs for supporting the pan; and
a transport assembly for transporting the pan, the table, and the frame separately from the stand, the transport assembly including a plurality of wheels coupled to one of the first end wall or second end wall of the pan, and a handle coupled to the other of the first end wall or second end wall of the pan.

2. The tile saw of claim 1, wherein each of the wheels is supported on the pan by a bracket.

3. The tile saw of claim 2, wherein the brackets are fastened to the pan.

4. The tile saw of claim 1, wherein the handle is rotatably coupled to the pan.

5. The tile saw of claim 1, wherein the handle is positioned between the second and third engagement members.

6. The tile saw of claim 1, further comprising first and second platforms configured to engage and support the frame within the pan, wherein the first and second platforms are positioned within the outer wall of the pan, and wherein the first and second platforms have a height that is lower than a height of the outer wall.

7. The tile saw of claim 6, wherein with the first platform is positioned proximate the first end wall and the second platform is positioned proximate the second end wall.

8. The tile saw of claim 7, wherein the first and second platforms are integral with the pan.

9. The tile saw of claim 6, further comprising an inner wall positioned within the outer wall and having a height that is lower than a height of the outer wall, wherein the inner wall extends between the first end wall and the second end wall to divide the volume into a first volume and a second volume less than the first volume.

10. The tile saw of claim 1, wherein the stand includes a plurality of side member formed by the legs, and wherein the side members are connected by a rod.

11. The tile saw of claim 10, wherein the pan further includes slots along a bottom side of the pan, and wherein the slots are configured to removably receive the rod of the stand.

12. The tile saw of claim 1, wherein the first engagement member is a pocket configured to receive a tab on the frame.

13. The tile saw of claim 1, wherein the second and third engagement members are over-center latches that are each configured to engage with a hook on the frame.

14. A pan for use with a tile saw having a frame and a saw supported on the frame, the pan comprising:
an inside bottom surface;
an outer wall extending around a perimeter of the inside bottom surface and together with the inside bottom surface, defining a volume capable of containing a liquid, the outer wall being formed by a first end wall, a second end wall spaced away from the first end wall, and first and second side walls extending between the first end wall and the second end wall;
first and second platforms configured to engage and support the frame within the pan, the first and second platforms positioned within the outer wall of the pan, the first and second platforms having a height that is lower than a height of the outer wall;
a connection assembly configured to removably couple the frame to the pan, the connection assembly having a first engagement member disposed on the first end wall of the pan and second and third engagement members disposed on the second end wall of the pan; and
a transport assembly for transporting the pan with the frame and saw attached thereto, the transport assembly including a plurality of wheels coupled to one of the first end wall or second end wall of the pan, and a handle coupled to the other of the first end wall or second end wall of the pan.

15. The tile saw of claim 14, wherein the first engagement member is a pocket configured to receive a tab on the frame.

16. The tile saw of claim 14, wherein the second and third engagement members are over-center latches that are each configured to engage with a hook on the frame.

17. The tile saw of claim 14, wherein each of the wheels is supported on the pan by a bracket.

18. The tile saw of claim 17, wherein the brackets are fastened to the pan.

19. The tile saw of claim 14, wherein the handle is rotatably coupled to the pan.

20. The tile saw of claim 14, wherein the handle is positioned between the second and third engagement members.
